(19) United States
(12) Patent Application Publication
(10) Pub. No.: US 2003/0099452 A1
(43) Pub. Date: May 29, 2003

(54) Manipulating the size of waveguides written into substrates using femtosecond laser pulses

(76) Inventors: Nicholas F. Borrelli, Elmira, NY (US); Joseph F. Schroeder, Lindley, NY (US); Alexander Streltsov, Painted Post, NY (US)

Correspondence Address: CORNING INCORPORATED, SP-TI-3-1, CORNING, NY, 14831

(21) Appl. No.: 09/997,751

(22) Filed: Nov. 28, 2001

(51) Int. Cl. G02B 6/10

(52) U.S. Cl. 385/129; 385/43; 430/290

(57) ABSTRACT

Waveguides produced in bulk glass using femtosecond pulsed lasers have diameters and refractive index profiles that are manipulated by additional motions or beams. For example, spot focuses of the femtosecond pulsed lasers trace overlapping or widened tracks by superimposing additional relative motions between the spot focuses and the bulk glass. Additional femtosecond pulsed beams can also be used to produced widened waveguides.

### TECHNICAL FIELD

Waveguide structures can be formed in a variety of glasses using ultra-short laser pulses of wavelengths beyond the absorption edges of the glasses. The pulses are focused at requisite intensities to induce local refractive index changes in the glasses and are relatively translated to trace light-guiding pathways within the glasses.

### BACKGROUND

Refractive index changes can be induced in a wide variety of glasses using ultra-short laser pulses having pulse durations in a range of 150 femtoseconds (fs) or less. The mechanism of induced index change is a non-linear phenomenon. The central wavelengths of the pulses are much longer than the absorption edge of the glasses, which makes possible the delivery actinic radiation to interior portions of the glasses.

The pulses are delivered in beams that are focused to near the diffraction limit to concentrate pulse energies within limited spot sizes. The resulting refractive index changes are confined to the spot focus of the beams. The spot focus can be relatively translated to produce modified-index tracks through bulk glasses. Index changes in the range of 1×10⁻³ to 5×10⁻³ have been found sufficient to support waveguiding properties along the tracks.

The pulse energies can vary between 2 nanojoules (nJ) and 1.5 microjoules (μJ) but are generally limited to more particular ranges by choice of glass material and laser. Insufficient pulse energies do not produce intensity levels required for inducing the intended index changes. Excessive pulse energies can produce physical damage that interferes with the propagation of light. Both the minimum energy values required to induce the desired change in refractive index and the maximum energy values that can be sustained without damage vary between glass types.

The lasers used for generating femtosecond pulses within the requisite wavelength and energy ranges are generally operated in two distinct modes. A Ti:Sapphire oscillator system produces pulse durations generally less than 150 femtoseconds (fs) in an energy range of 1 nJ to 10 nJ and at a repetition rate in the megahertz (MHz) range. A Ti:Sapphire amplifier system produces pulse durations less than 150 femtoseconds (fs) in an energy range of 1 μJ to 1 millijoule (mJ) and at a repetition rate in the kilohertz (kHz) range.

Waveguides can be written into bulk glass materials such as borosilicate, sulfide, and lead glasses using the lower energy but higher repetition rates of femtosecond laser oscillators with little risk of damage. However, high-silica-content glasses generally require the higher pulse energies of femtosecond laser amplifiers to write similar waveguides. Rates of translation between the glasses and the spot focuses of the femtosecond lasers are adjusted to most efficiently reproduce the desired index change along prescribed tracks.

The spot focuses of the femtosecond lasers generally produce small diameter waveguides on the order of about 2 microns (μm) to 3 microns (μm). Given an index change on the order of 10⁻³, the waveguiding properties of the small diameter waveguides are relatively weak. Where, as here, both the change in index and the waveguide diameter are comparatively small, a substantial portion of signal strength is carried in a surrounding medium (e.g., a cladding) of the waveguide. Signal losses are larger for signals that significantly encroach upon the surrounding medium.

Waveguide diameters have been enlarged by increasing the average power of the writing laser, which increases the effective dimensions of the spot size. Although increases in power can produce index changes over larger areas, the power increases can change the desired refractive index profile of the waveguide as well as damage the glass by forming voids and other defects that can interfere with waveguiding properties.

### SUMMARY OF INVENTION

Transverse dimensions of waveguides written into bulk glasses using femtosecond pulse lasers can be manipulated in accordance with our invention without increasing pulse power or damaging the glass. Both transverse areas and shapes of the waveguides can be manipulated. In addition, further control over the refractive index profile of the waveguides is also possible.

The waveguide improvements are made using pulsed laser beams having wavelengths longer than the absorption edge of glass substrates and pulse durations less than 150 femtoseconds (fs). The pulsed laser beams irradiate spots within the glass substrates at intensities sufficient to induce localized refractive index changes in the glass substrates.

One embodiment involves relatively translating the glass substrate with respect to the spot of irradiation so that the spot of irradiation traces a first section of the optical waveguide in the substrate distinguished by a refractive index difference with respect to surrounding portions of the substrate. A further relative translation of the glass substrate with respect to the spot of irradiation traces a second section of the optical waveguide also distinguished by a refractive index difference with respect to surrounding portions of the substrate. The first and second sections of the optical waveguide are juxtaposed for enlarging the transverse area of the optical waveguide normal to a direction of the relative translation between the substrate and the spot of irradiation.

The two sections of the optical waveguide are preferably two of a larger plurality of sections that extend substantially parallel to each other in a substantially contiguous transverse pattern so that the index change throughout the transverse area of the optical waveguide is substantially uninterrupted. However, the sections are preferably relatively positioned so that the index difference induced along one section is not substantially changed by the index difference induced in adjacent sections. In addition, the focusing characteristics of the irradiated spots are preferably not affected by the index changes induced by adjacent irradiated spots.

For example, centers of the sections traced by the relative motions can be arranged in transverse section as vertices of a polygon. In addition, one of the sections can be located at a center of the waveguide and other of the sections are located around a periphery of the waveguide. The refractive index difference induced in the center section can differ from the refractive index difference induced in the peripheral sections for adjusting a refractive index profile of the waveguide.

Another embodiment defines the relative motion between the substrate and the spot of irradiation as including a first component that enlarges a longitudinal dimension of the waveguide corresponding to an intended direction of light propagation along the waveguide and a second component that enlarges a transverse dimension of the waveguide normal to the intended direction of light propagation along the waveguide. Preferably, the second component of the relative motion undergoes a periodic change in direction, such as rotation or oscillation. For example, the combined components of the relative motion can produce a helical motion between the substrate and the spot of irradiation.

Transverse dimensions of the waveguide can be altered along the length of the waveguide by varying the second component of the relative motion as a function of a change in the longitudinal dimension of the waveguide. Adiabatic transitions can be made in this way for coupling the waveguides to other optical structures.

Another embodiment provides for producing a plurality of laser beams, each having a wavelength beyond an absorption edge of the substrate and a pulse duration less than 150 femtoseconds (fs). The plurality of laser beams irradiate a plurality of adjacent spots within the substrate at intensities sufficient to induce localized refractive index changes in the substrate. The substrate and the adjacent spots are relatively translated to trace a waveguide in the substrate having a longitudinal dimension in the direction of translation and a transverse area filled by the plurality of adjacent spots.

The plurality of laser beams can be divided from the same source or produced individually or in groups from different sources. The irradiated spots are preferably arranged in an evenly distributed pattern to produce a waveguide having a radially symmetric refractive index profile. Generally, the adjacent spots irradiated by the laser beams are arranged to fill a circular transverse area of the waveguide.

### DRAWINGS

FIG. 1 is a diagram showing an exemplary system for writing waveguides in bulk glasses using femtosecond pulsed lasers. The bulk glass is mounted on a motorized stage to control both longitudinal and transverse dimensions of the waveguides.

FIG. 2 is a side view of a plurality of adjacent parallel traces formed in the bulk glass.

FIG. 3 is an end view of a waveguide formed by an assembly of adjacent traces arranged in a pattern for producing a round waveguide.

FIG. 4 is an end view of a waveguide formed by an assembly of adjacent traces arranged in a pattern for producing an elliptical waveguide.

FIG. 5 is a side view of a plurality of adjacent traces in a converging pattern.

FIG. 6 is a diagram showing a combination of translation and rotation imparted to an offset spot focus for enlarging a transverse dimension of a waveguide.

FIG. 7 is an end view showing the rotational motion of FIG. 6 applied to a round spot focus for producing a round waveguide having an enlarged transverse diameter.

FIG. 8 is another diagram showing a combination of translation and rotation imparted along an axis through a spot focus.

FIG. 9 is an end view showing the rotational motion of FIG. 8 applied to an oblong spot focus for producing a round waveguide having a transverse diameter matching a long dimension of the spot focus.

FIG. 10 is a diagram showing another exemplary system for writing waveguides in bulk glasses using femtosecond pulsed lasers. A single beam is divided into a plurality of beams for enlarging transverse dimensions of a waveguide.

FIG. 11 is a refractive-index map of the waveguide enlarged by an array of parallel tracks along with two plots showing orthogonally related refractive index profiles of the waveguide.

FIG. 12 is a refractive-index map of the waveguide enlarged by a relative helical motion of a spot focus along with two plots showing orthogonally related refractive index profiles of the waveguide.

### DETAILED DESCRIPTION

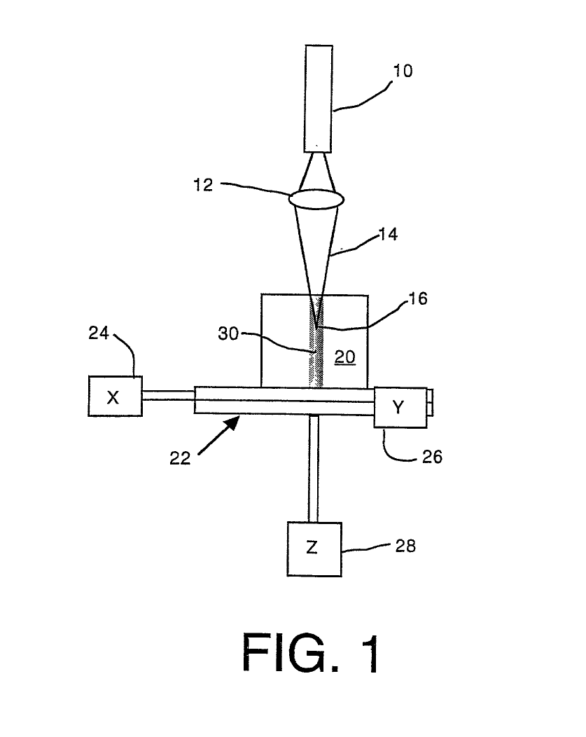

An exemplary writing system depicted in FIG. 1 includes a femtosecond laser 10, which can be of the amplifier or oscillator type. For example, the laser can be a Ti:Sapphire multi-pass amplifier or a Ti:Sapphire oscillator. The choice laser depends largely on material properties of a glass substrate 20 within which a waveguide 30 is intended to be written. Laser performance characteristics such as laser wavelength, pulse duration, pulse energy, and repetition rate can be collectively optimized for different glass materials. Stability and other overall performance characteristics of the lasers can also be considered for improving accuracy and efficiency of the writing process.

Detailed examples of femtosecond laser amplifier and oscillator writing systems are found in co-assigned U.S. patent application Ser. No. 09/628,666 entitled Femtosecond Laser Writing of Glass, Including Borosilicate, Sulfide, and Lead Glasses and Ser. No. 09/627,868 entitled Direct Writing of Optical Devices in Silica-Based Glass, both of which are hereby incorporated by reference. Other laser types, including cavity-dump lasers, can be used as appropriate for matching laser performance characteristics to material properties of the glass substrate 20.

A beam 14 output from the laser 10 is focused by conventional focusing optics 12 to a spot 16 within the glass substrate 20. Preferably, the beam 14 is focused to a spot size near the diffraction limit to concentrate pulse energies. Numerical apertures above 0.2 are generally preferred to limit the focal spot diameter at which the beam 14 is effective for producing a localized change in the refractive index. However, a tradeoff is involved. Increases in numerical aperture also have the effect of decreasing working distance, which can limit the depth at which the waveguide 30 can be written into the glass substrate 20.

The exposure wavelength should be longer than the absorption edge of the glass substrate 20 to support uninhibited transmissions of the beam 14 into the interior of the glass substrate 20. However, the exposure wavelength is preferably within a multiple of two times the absorption edge to limit the amount of energy needed to induce a refractive index change in the glass substrate 20.

Pulse duration (width) should be as short as possible to achieve the highest intensities with the least amount of pulse energy. However, excessive pulse energies can result in damage that interferes with the waveguiding properties of the resulting waveguide 30. The femtosecond pulses are defined at less than 150 femtosecond duration, but pulses as short as 20 femtoseconds are favored to achieve the desired intensity with limited pulse energy. Pulses much below 20 femtoseconds are known to disperse through both air and glass.

Ti:Sapphire femtosecond amplifiers are capable of producing good quality index changes in glass materials such as fused silica and borosilicates. However, the pulse energies of femtosecond amplifiers are capable of producing thermal damage in the glass materials. Although the kilohertz (kHz) duty cycle of femtosecond amplifiers is longer than the thermal diffusion time of the considered glasses (i.e., each pulse heats independently of the others), instantaneous temperatures can rise to more than 1000 degrees centigrade (C). At numerical apertures of 0.26, pulse energies are preferably limited to 0.8 microjoules (μJ) for fused silica and 0.5 microjoules (μJ) for borosilicates.

Ti:Sapphire femtosecond oscillators are capable of producing good quality index changes in glass materials such as borosilicate, sulfide, and lead glasses. Even though the duty cycle [approximately 10-13 nanoseconds (ns)] is much less than the thermal diffusion time of the considered glasses, the pulse energy of such oscillators is too low [less than 10 nanojoules (nJ)] to produce any counterproductive thermal effects. Accumulated local temperatures generally remain below 200 degrees centigrade (C). Femtosecond oscillators also have better temporal and pointing stability than femtosecond amplifiers and are generally preferred if capable of making the required index change in the considered glass material.

The spot focus 16 within the glass substrate 20 at which the laser beam 14 is focused is relatively movable with respect to the glass substrate 20 for writing the desired waveguide 30 into the glass substrate 20. The relative motion can be produced by moving either the spot focus 16 or the glass substrate 20 or by moving both the spot focus 16 and the glass substrate 20. In the arrangement depicted in FIG. 1, the glass substrate 20 is mounted on an XYZ coordinate motion table 22. Separate computer controlled drives 24, 26, and 28 provide for translating the glass substrate 20 in three orthogonal directions. The coordinated motions preferably maintain an entry surface of the glass substrate 20 normal to the incident beam 14.

The translations along the three coordinate axes (X, Y, and Z) can trace any desired curvilinear path of the spot focus 16 through the glass substrate 20. The overall curvilinear path of the spot focus 16 in the glass substrate 20 traces a longitudinal dimension of the waveguide 30. However, in accordance with the current embodiment of the invention, supplemental motions are also imparted along the same orthogonal axes to enlarge a transverse area of the waveguide 30.

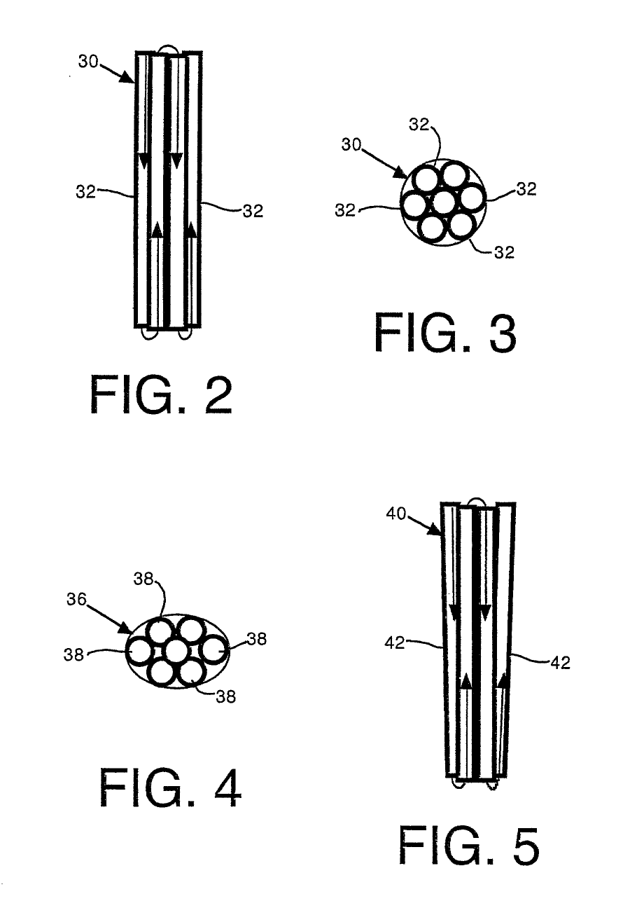

For example, FIG. 2 shows tracks 32 of the spot focus 16 in an axial X-Z plane. The tracks 32 are made in sequence following offset but overlapping (e.g., contiguous) parallel paths through the glass substrate 20. In FIG. 3, seven parallel tracks 32 are shown in cross section in a transverse X-Y plane clustered to form contiguous sections of the waveguide 30. A transverse area of the waveguide 30 is shown greatly enlarged with respect to the individual tracks 32 of the spot focus 16.

Six of the seven tracks 32 are positioned at vertices of a regular hexagon. The remaining track 32 is centered within the polygonal pattern. Other arrangements of parallel tracks 32 including other regular polygons can be used to form circular waveguides having larger or smaller diameters. The arrangements of the tracks 32 for forming circular cross-sectioned waveguides are preferably evenly distributed about a circular perimeter. Regular polygonal distributions are preferred for this purpose. However, if the spot focus 16 itself departs from circularity, the pattern of parallel tracks 32 can be varied to compensate.

The multiple tracks 32, particularly distinctions between the tracks 32 forming a perimeter of the waveguide 30 and the track 32 forming the center of the waveguide, can also be used to vary the refractive index profile of the waveguide. For example, the refractive index change induced by the centermost track 32 can be either more or less than the refractive index change induced by the perimeter tracks 32. Relative rates of translation between the spot focus 16 and the glass substrate 20 can be varied to control the refractive index change. The number and pattern of tracks 32, the spacing between the tracks 32, the size of the spot focus 16, and other variables including pulse energy, wavelength, repetition rate, and focusing characteristics can also be varied to distinguish the tracks 32. The modified profile shapes can be used for such purposes as chromatic dispersion compensation or multi-modal transmissions. So-called alpha profiles can be constructed for the latter purpose.

The number of parallel tracks 32 can be varied depending on the desired size and refractive index profile of the waveguide 30. Enough tracks are needed within a given transverse area to sufficiently approximate the desired cross-sectional shape of the waveguide 30 and to achieve the desired refractive index profile. However, too many tracks 32 within a defined transverse area can interfere with the focusing of the spot focus 16 for writing adjacent tracks 32. Such overwriting of adjacent tracks 32 can also damage the overwritten tracks 32 and diminish their transmissive qualities.

Preferably, the index change induced along one of the tracks 32 is independent of the index change produced along adjacent tracks 32. Pulse energies can be reduced or other operating variables modified to avoid some complexities associated with overwriting adjacent tracks 32. Unless a more specific refractive index profile is desired, the distribution of the tracks 32 and the other operating variables are arranged to produce a maximum change in index throughout the cross-sectional area of the waveguide 30 without incurring thermal damage to waveguiding properties.

As shown in FIG. 4, a non-circular cross-section waveguide 36 can be formed by irregular (e.g., elliptical) distributions of parallel tracks 38. For example, waveguides for maintaining a particular polarity can be formed in this way.

In FIG. 5, tracks 42 depart from parallel to form a longitudinally tapering waveguide 40. The taper can be an increasing or decreasing taper. The variables affecting the change in refractive index, including translation rate, spot focus size, repetition rate, pulse energy, wavelength, and focusing, can also be varied along the length of the waveguide 40 to compensate for varying amounts of overlap between the tracks 42 or to modify the waveguiding properties of the waveguide 40. The waveguide modifications can be made in conjunction with waveguide taper or independently of the taper.

Instead of enlarging waveguides by writing adjacent tracks, the invention also involves imparting multidimensional relative motion, one component modifying a longitudinal dimension of a waveguide and another component modifying a transverse dimension of the waveguide. The latter component is preferably a cyclical component involving rotation, oscillation, or nutation.

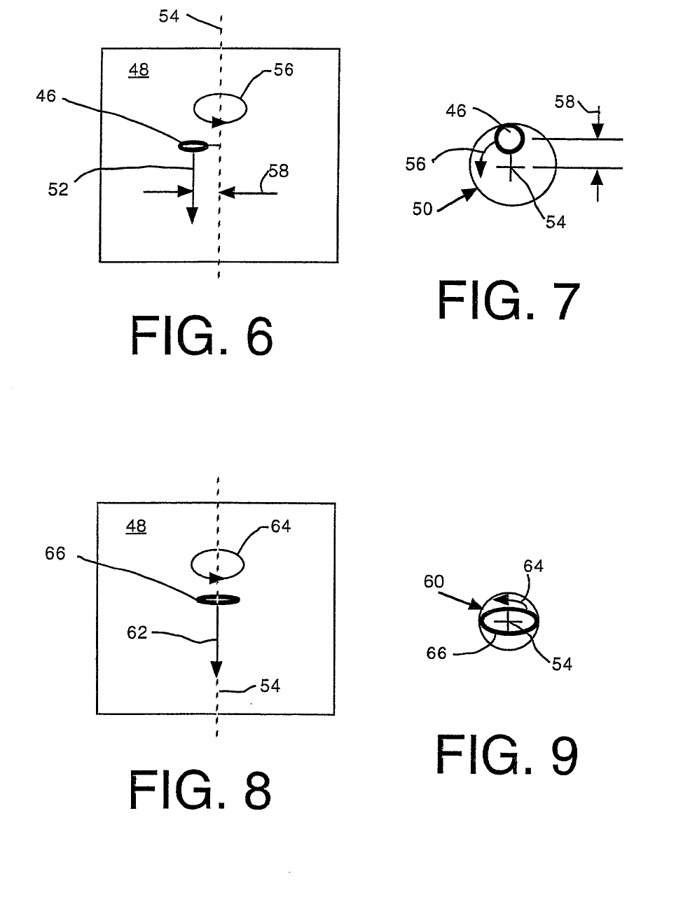

For example, FIGS. 6 and 7 depict an arrangement for enlarging a diameter of a waveguide 50 by imparting a relative helical motion between a spot focus 46 and a glass substrate 48. The relative helical motion includes a linear component 52 relatively advancing the spot focus 46 parallel to an axis 54 for extending a longitudinal dimension of the waveguide 50 and a rotational component 56 relatively rotating the spot focus 46 at an offset 58 from the axis 54 for circumscribing an intended transverse dimension of the waveguide 50.

The relative rotation of the spot focus 46 can be accomplished by the combined translating motions of the XYZ coordinate motion table 22 of FIG. 1. For example, the linear component 52 can be imparted by the drive 28 in the Z coordinate direction. The rotational component 56 can be imparted by the drives 24 and 26 for producing a curvilinear motion in the X-Y coordinate plane. Alternatively, the drive 28 or any of the others could be supplemented to impart angular motion directed along the Z axis or along either of the remaining two axes.

The size of the spot source 46 and the amount of the offset 58 from the longitudinal axis 54 of the waveguide 50 determines the perimeter size of the waveguide 50 in a single pass (trace). However, the amount of the offset 58 can be varied within the single pass (e.g., in a spiral pattern) or between multiple passes for further enlarging a transverse area of the waveguide 50. Variations in relative motion can also be made as a substantially linear function of longitudinal position to produce tapering waveguides or as a higher order function to accomplish such purposes as filtering, coupling, routing, and chromatic or polarization compensation.

A combination of linear motion 62 and angular motion 64 along the axis 54 is depicted in FIGS. 8 and 9 as a way of compensating for an oblong-shaped spot focus 66 in the manufacture of a round waveguide 60. The spot source 66 is centered on the axis 54 along which both the linear motion 62 and the angular motion 64 take place. The resulting waveguide 60 has a transverse diameter equal to the oblong dimension of the spot focus 66.

Alternatively, a round or oblong spot source can be used to produce a waveguide having an oblong or other dimensionally modified transverse shape by combining a transverse oscillating motion with the linear motion along the axis 54. The linear motion along the axis 54 for producing a longitudinal dimension of a waveguide can be supplemented with additional motions to produce a waveguide having a curvilinear longitudinal shape.

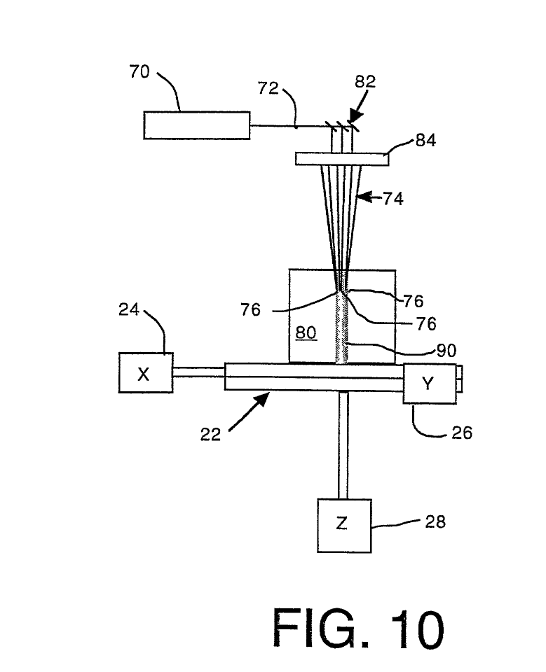

An alternative writing system depicted in FIG. 10 divides a single beam 72 from a laser source 70 into a plurality of beams 74 for simultaneously writing different portions of a waveguide 90. A beam divider 82 separates the beams 74; and a focusing system 84, which can be composed of individual or collective focusing optics, focuses the beams 74 to individual spot focuses 76 within a glass substrate 80. The spot focuses 76 can be arranged in various patterns to produce different transverse sections of the waveguide 90 similar to the repeating patterns of FIGS. 2-5. However, the spot focuses 76 can also be varied by different focusing characteristics to further influence waveguide shape or refractive index profile.

The same XYZ coordinate motion table 22 from FIG. 1 is also depicted in FIG. 10 for imparting relative motion between the spot focuses 76 and the glass substrate 80. The relative motion can be limited to the motions required for extending a longitudinal dimension of the waveguide 90 or can include additional components of motion for modifying a transverse dimension of the waveguide 90 beyond the pattern of the spot focuses 76. For example, a round waveguide could be formed by superimposing an angular component of motion to a pair of spot focuses. Such rotation can be used to add radial symmetry to both the transverse shape and the refractive index profile of the waveguide 90.

Although the beams 74 are divided from a single source 70 in FIG. 10, more than one source can be used for producing the beams. For example, the different source beams can have different characteristics such as different pulse energy, pulse duration, wavelength, or repetition rate to further influence the refractive index profile of the resulting waveguide.

The intended longitudinal dimensions of the waveguides 30, 36, 40, 50, 60, or 90 are preferably extended substantially in the direction of propagation of the writing beams 14 or 74. The transverse dimensions of the waveguides 30, 36, 40, 50, 60, or 90 are preferably formed by their spot focuses 16 or 76 in combination with any relative linear or angular motion between the spot focuses 16 or 76 and the glass substrates 20 or 80 substantially normal to the writing beam propagation direction. However, similar waveguides could also be written with transverse dimensions in the beam propagation direction and longitudinal dimensions normal to the beam propagation direction.

### EXAMPLE A

A Ti:Sapphire femtosecond laser oscillator arranged in accordance with the system of FIG. 1 generates a 400 nanometer (nm) beam composed of an 80 megahertz (MHz) train of 25 femtosecond pulses. The beam was focused into a glass sample of borosilicate glass (Corning Code 7890) having an absorption edge around 300 nm by a Mitutoyo 20 millimeter (mm) focal length objective having a numerical aperture of 0.28. The resulting spot focus was elliptical in shape having dimensions of 1.3 microns (μm) by 2.5 microns (μm).

Six waveguide tracks were written at a spacing of approximately 0.5 microns (μm) in the pattern of a hexagon. A seventh waveguide track was written at a center of the pattern. The relative motion for producing the tracks was provided by an Aerotech ALS130 three-dimensional motorized translation stage. The resulting waveguide had a 3 micron (μm) by 4 micron (μm) transverse dimension defined by a refractive index modification approaching 0.005 as measured by a refractive near-field profilometer (RNF).

FIG. 11 is a diagram showing the refractive index profiles in two orthogonal directions. This approach allows for writing waveguides having cylindrical or elliptical transverse shapes. The enlarged diameter waveguides support smaller bending radii for reducing device size. In addition to varying waveguide dimensions, the multiple tracks can be used to vary index change (refractive index profile) with waveguide radius.

### EXAMPLE B

A Ti:Sapphire femtosecond laser amplifier arranged in accordance with the system of FIG. 1 generates a 800 nanometer (nm) beam composed of an 20 kilohertz (kHz) train of 40 femtosecond pulses having a pulse energy of 0.75 microjoules (μJ). The beam was focused into a glass sample and translated in a helical pattern at a relative velocity of 20 microns (μm) per second at a thread step size of 10 microns (μm). A spot size of approximately 2 microns (μm) produced better results than a spot size of approximately 4 microns (μm).

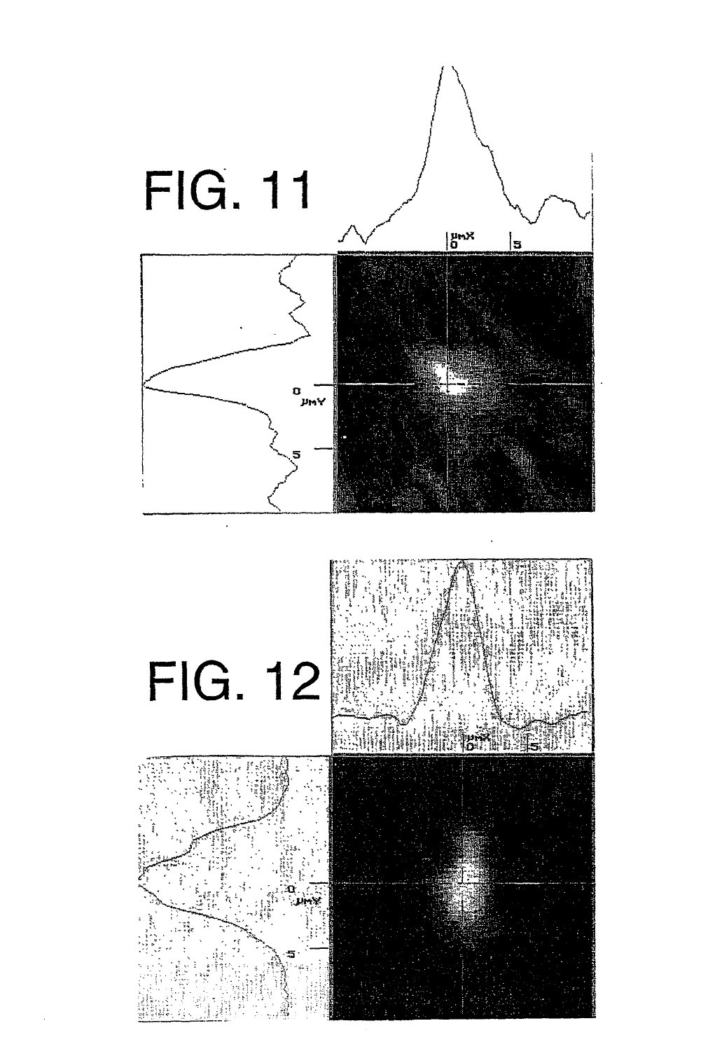

FIG. 12 shows a cross section of the resulting transverse dimensions of the waveguide measuring approximately 3.5 microns (μm) by 6.5 microns (μm) with a refractive index change of approximately 0.005.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

We claim:

1. A method of enlarging a transverse dimension of a waveguide written into a substrate by femtosecond laser pulses comprising the steps of:
producing a beam comprising a succession of pulses having pulse durations less than 150 femtoseconds and central wavelengths longer than an absorption edge of the substrate;
focusing the beam within the substrate to a spot focus at an intensity that produces an index change in the substrate at the spot focus;
relatively moving the substrate with respect to the spot focus of the beam along a first track of relative motion for producing a waveguide within the substrate, the waveguide having a longitudinal dimension along the first track of relative motion and a transverse dimension normal to the first track of relative motion; and
further relatively moving the substrate with respect to the spot focus of the beam adjacent to the first track of relative motion for enlarging the transverse dimension of the waveguide within the substrate.

2. The method of claim 1 in which the step of further relatively moving includes relatively moving the substrate with respect to the spot focus along a second track of relative motion adjacent to the first track.

3. The method of claim 2 in which an index change produced by the relative motion along the first track is substantially independent of an index change produced by the relative motion along the second track.

4. The method of claim 2 in which the second track along which the substrate and the spot focus are relatively moved is substantially parallel to the first track.

5. The method of claim 3 in which the second track of relative motion is one of a plurality of tracks of relative motion along which the substrate and the spot focus are relatively moved substantially parallel to the first track.

6. The method of claim 5 in which the plurality of tracks of relative motion are regularly spaced apart from each other.

7. The method of claim 6 in which the plurality of tracks intersect a transverse plane normal to a direction of the relative motion as vertices of a regular polygon.

8. The method of claim 1 in which the relative motion along the first track and the further relative motion adjacent to the first track are simultaneously imparted as components of a combined relative motion of the substrate and the spot focus.

9. The method of claim 8 in which the step of further relatively moving includes superimposing an instantaneous velocity component normal to the direction of the relative motion of the substrate and the spot focus along the first track.

10. The method of claim 9 in which the combined relative motion of the substrate and the spot focus produces a transverse shape of the waveguide that differs from a transverse shape of the spot focus.

11. The method of claim 10 in which the transverse shape of the waveguide produced by the combined relative motion is more elliptical than the transverse shape of the spot focus.

12. The method of claim 10 in which the transverse shape of the waveguide produced by the combined relative motion is less elliptical than the transverse shape of the spot focus.

13. The method of claim 9 in which the instantaneous velocity component is generated by relative motion comparable to an instantaneous angular velocity along an axis offset from the spot focus and extending in the direction of the relative motion of the substrate and the spot focus along the first track.

14. The method of claim 9 in which the combined relative motion is a relative helical motion between the substrate and the spot focus.

15. The method of claim 8 in which the spot focus has a noncircular shape and the step of further relatively moving includes superimposing an instantaneous angular velocity along an axis intersecting the spot focus and extending in the direction of the relative motion of the substrate and the spot focus along the first track for forming a more circular transverse shape of the waveguide.

16. The method of claim 1 in which the further relative motion of the substrate with respect to the spot focus of the beam is varied as a function of longitudinal position of the spot focus along the first track.

17. The method of claim 16 in which the further relative motion varies the transverse dimension of the waveguide as a function of a change in the longitudinal dimension of the waveguide.

18. A waveguide written into a substrate by femtosecond laser pulses in accordance with the method of claim 1.

19. The waveguide of claim 18 in which the waveguide has a diameter substantially larger than the diameter of the spot focus used for producing the waveguide.

20. A method of enlarging a transverse area of an optical waveguide written by femtosecond laser pulses into a substrate comprising the steps of:
producing a pulsed laser beam having a wavelength beyond an absorption edge of the substrate and a pulse duration less than 150 femtoseconds (fs);
irradiating a spot within the substrate with the pulsed laser beam at an intensity sufficient to induce a localized refractive index change in the substrate;
relatively translating the substrate with respect to the spot of irradiation so that the spot of irradiation traces a first section of the optical waveguide in the substrate distinguished by a refractive index difference with respect to surrounding portions of the substrate;
further relatively translating the substrate with respect to the spot of irradiation so that the spot of irradiation traces a second section of the optical waveguide distinguished by a refractive index difference with respect to surrounding portions of the substrate; and
juxtaposing the first and second sections of the optical waveguide for enlarging the transverse area of the optical waveguide normal to a direction of the relative translation between the substrate and the spot of irradiation.

21. The method of claim 20 in which said steps of relatively and further relatively translating are sequential operations.

22. The method of claim 20 in which the step of further relatively translating includes further relatively translating the substrate with respect to the spot of irradiation a plurality of times so that the spot of irradiation traces more than two sections of the optical waveguide.

23. The method of claim 22 in which the sections of the optical waveguide extend substantially parallel to each other.

24. The method of claim 22 in which the sections at least partially converge to form a tapered waveguide.

25. The method of claim 22 in which focusing qualities associated with the spot of irradiation tracing one of the sections is not affected by index changes associated with tracing adjacent sections.

26. The method of claim 22 in which the sections are substantially contiguous so that the index change throughout the transverse area of the optical waveguide is substantially uninterrupted.

27. The method of claim 22 in which the sections are arranged as vertices of a polygon.

28. The method of claim 22 in which the one of the sections is located at a center of the waveguide and other of the sections are located around a periphery of the waveguide.

29. The method of claim 28 in which the refractive index difference induced in the center section differs from the refractive index difference induced in the peripheral sections for adjusting a refractive index profile of the waveguide.

30. A waveguide written by femtosecond laser pulses into a substrate in accordance with the method of claim 20.

31. A waveguide written by femtosecond laser pulses into a substrate in accordance with the method of claim 29 in which the waveguide has a refractive index profile in which the refractive index difference induced in the center section differs from the refractive index difference induced in the peripheral sections of the waveguide.

32. A method of varying a transverse area of a waveguide written into a substrate using femtosecond laser pulses comprising the steps of:
producing a pulsed laser beam having a wavelength beyond an absorption edge of the substrate and a pulse duration less than 150 femtoseconds (fs);
irradiating a spot within the substrate with the pulsed laser beam at an intensity sufficient to induce a localized refractive index change in the substrate;
relatively moving the substrate with respect to the spot of irradiation for producing the waveguide within the substrate;
the relative motion including a first component enlarging a longitudinal dimension of the waveguide corresponding to an intended direction of light propagation along the waveguide; and
the relative motion including a second component enlarging a transverse dimension of the waveguide normal to the intended direction of light propagation along the waveguide.

33. The method of claim 32 in which the second component of the relative motion undergoes a periodic change in direction.

34. The method of claim 33 in which the second component of the relative motion is subject to rotation.

35. The method of claim 34 in which the relative motion is a helical motion between the substrate and the spot of irradiation.

36. The method of claim 32 in which the first and second components of the relative motion are orthogonal components.

37. The method of claim 36 in which the first component of the relative motion is subject to a linear velocity and the second component of the relative motion is subject to an angular velocity.

38. The method of claim 36 in which the second component of the relative motion is varied as a function of a change in the longitudinal dimension of the waveguide to vary the transverse area of the waveguide with respect to the longitudinal dimension of the waveguide.

39. A waveguide written into a substrate using femtosecond laser pulses according to the method of claim 32.

40. A waveguide written into a substrate using femtosecond laser pulses according to the method of claim 38 in which the transverse area of the waveguide is tapered in the longitudinal dimension of the waveguide.

41. A method of writing an optical waveguide in a substrate using femtosecond laser pulses comprising the steps of:
producing a plurality of pulsed laser beams, each having a wavelength beyond an absorption edge of the substrate and a pulse duration less than 150 femtoseconds (fs);
irradiating a plurality of adjacent spots within the substrate with the plurality of pulsed laser beams at intensities sufficient to induce localized refractive index changes in the substrate; and
relatively translating the substrate with respect to the plurality of adjacent spots tracing a waveguide in the substrate having a longitudinal dimension in the direction of translation and a transverse area filled by the plurality of adjacent spots.

42. The method of claim 41 in which the plurality of pulsed laser beams are produced by a common source.

43. The method of claim 41 in which the adjacent spots are evenly distributed within the transverse area of the waveguide.

44. The method of claim 41 in which the adjacent spots produce a waveguide having a radially symmetric refractive index profile.

45. The method of claim 41 in which the adjacent spots are arranged to fill a circular transverse area of the waveguide.

46. The method of claim 41 including the further step of varying performance characteristics between the beams.

47. The method of claim 46 in which focusing characteristics are varied between the beams.

48. The method of claim 46 in which intensity characteristics are varied between the beams.
